(19) United States
(12) Patent Application Publication
(10) Pub. No.: US 2005/0003208 A1
(43) Pub. Date: Jan. 6, 2005

(54) Method of reducing the color contribution of a coated top layer in a multi-layer material

(76) Inventors: John Frederick Graf, Ballston Lake, NY (US); James Edward Pickett, Schenectady, NY (US)

Correspondence Address: Raymond E. Farrell, Esq.;Carter, DeLuca, Farrell & Schmidt, LLP, Suite 225, 445 Broad Hollow Road, Melville, NY, 11747, US

(21) Appl. No.: 10/611,729

(22) Filed: Jul. 1, 2003

(51) Int. Cl. B32B 27/36; B32B 27/06; B32B 15/04; B32B 27/00; B32B 17/06

(52) U.S. Cl. 428/426; 428/457; 428/480; 428/500

(57) ABSTRACT

Methods to reduce the inherent color contribution of a top layer in a multi-layer article (10) are disclosed. The articles produced thereby have reduced yellowing and thus lower amounts of color compensating pigments and dyes must be added in order to achieve the desired color of the article. The multi-layer material (10) includes a surface film (12), a substrate (14) and an intermediate layer (13) therebetween.

### BACKGROUND

1. Technical Field

This disclosure is directed to weatherable multi-layer articles and a method to reduce the inherent color contribution of a top layer in a multi-layer article, thus reducing the amount of color compensating pigments and dyes that must be added in order to achieve the desired color of the article. Where the articles are to be white, the method of the present disclosure reduces yellowing and allows lighter whites to be obtained.

2. Background of Related Art

Various polymeric articles have a problem of long term color instability. This causes yellowing of the polymer, detracting from its transparency and attractiveness. Loss of gloss is another undesirable characteristic which can occur over time.

Yellowing of polymers is often caused by the action of ultraviolet radiation, which is why such yellowing is frequently designated “photoyellowing”. Numerous means for suppressing photoyellowing have been employed and proposed. Many of these involve incorporation in the polymer of ultraviolet absorbing compounds (UVAs). For the most part, UVAs are low molecular weight compounds which must be employed at relatively low levels, typically up to 1% by weight, to avoid degradation of the physical properties of the polymer (such as impact strength) and high temperature properties (such as heat distortion temperature). However, low levels of UVAs may be inadequate to afford sufficient protection and photoyellowing of the polymer may still occur.

One way of protecting a resinous article against photoyellowing and loss of gloss is to apply a coating of a weatherable second polymer, the term “weatherable” as used herein signifying resistance to such phenomena. Coatings made from polyesters containing resorcinol arylate units often possess good weatherability properties. The arylate moieties typically contain isophthalate, terephthalate, and especially mixtures of iso- and terephthalate units. Polyesters of resorcinol with mixtures of isophthalate and terephthalate chain members typically have good weatherability properties and may provide protection against photoyellowing when coated over a resinous substrate.

Polyesters containing resorcinol arylate chain members have been prepared by melt methods as disclosed in U.S. Pat. No. 4,127,560 and in Japanese Kokai 1/201,326. The methods may provide polyesters containing isophthalate and terephthalate chain members but do not allow the incorporation of greater than 30 mole % terephthalate. In addition, the polyesters obtained have a light yellow to amber color which, in many cases, is unacceptable.

Polyesters containing resorcinol arylate chain members have also been prepared by an interfacial method. The interfacial method comprises a solvent mixture containing water and at least one organic solvent substantially immiscible with water. According to U.S. Pat. No. 3,460,961 and Eareckson, Journal of Polymer Science, vol. XL, pp. 399-406 (1959), preparation of resorcinol arylate polyesters with a mixture of iso- and terephthalate chain members can be performed by an interfacial method in water and a water-immiscible solvent such as chloroform or dichloromethane using 1:1 stoichiometric ratio of resorcinol to either iso- or terephthaloyl dichloride, or a mixture thereof, in the presence of aqueous sodium hydroxide.

Copolyesters comprising resorcinol iso- and terephthalate polyester chain members in combination with diacid or diol alkylene chain members (so-called “soft-block” chain members) are disclosed in U.S. Pat. No. 5,916,997. These copolymers have excellent weatherability and flexibility. Copolyestercarbonates comprising resorcinol iso- and terephthalate polyester chain members in combination with carbonate chain members are disclosed in U.S. Pat. No. 6,559,270. These copolymers also have excellent weatherability and are compatible with polycarbonates in blends.

The good weatherability properties of polyesters containing resorcinol arylate units are believed to arise in large part from the screening effect said polymers may provide to ultraviolet (UV) light. On exposure to UV light, polymers comprising resorcinol arylate chain members may undergo photochemical Fries rearrangement converting at least a portion of the polymer from polyester chain members to o-hydroxybenzophenone-type chain members. The o-hydroxybenzophenone-type chain members act to screen further UV light and protect UV-sensitive components in a resorcinol arylate-containing composition. The good weatherability properties of polymers comprising resorcinol arylate chain members make them especially useful in blends and in multilayer articles in which said polymers may act as a protecting layer for more sensitive substrate components.

Multilayer articles containing layers made from resorcinol arylate-containing polyester have been described by Cohen et al., J. Poly. Sci., Part A-1, 9, 3263-3299 (1971), and certain related U.S. patents of Monsanto Company including U.S. Pat. Nos. 3,444,129, 3,460,961, 3,492,261 and 3,503,779. The method disclosed therein for the application of the weatherable polymer is by solution coating followed by evaporation of the solvent.

Japanese Kokai 1/199,841 discloses articles having a substrate layer comprising at least 90 mole percent poly(ethylene terephthalate) and a gas barrier coating layer which is a polyester of resorcinol and isophthalic acid, optionally with copolyester units derived from another dicarboxylic acid such as terephthalic acid, naphthalenedicarboxylic acid or various other specifically named dicarboxylic acids. The disclosed articles may be prepared by a series of operations including co-injection molding which are essentially performed entirely in the melt, thereby overcoming some of the problems associated with solution coating.

Other methods for applying weatherable polymers to articles which do not require the use of solvents are known, and include methods which apply a coating layer in the melt as described in U.S. Pat. No. 6,572,956.

In multi-layer materials, pigments and dyes must be added to one or more of the layers to achieve the desired color of the material. If one or more of these layers is made of a material that has an inherent base color, such as a yellow tint, extra colorants (i.e. pigments and dyes) must be added in order to compensate for the inherent base color. One problem with the use of resorcinol-based arylates in multi-layer articles is that although they will improve resistance of a resinous substrate to photoyellowing, the resorcinol-based arylate itself frequently has a yellowish hue.

Thus, in order to make a white multi-layer article which includes a material that has a yellow tint inherent in its top layer, extra blue and red colorant must be added to make a non-chromatic white color. However, adding blue and red colorants also reduces the over-all lightness of the color.

In materials where the inherent base color, i.e. yellow, is strong, it may not be possible to make a white article having sufficient lightness, i.e., the perceived reflectance of the article. Furthermore, if the top layer has an inherent base yellow and compensating colorants cannot be added thereto, e.g., colorants cannot be added in an amount sufficient to reduce the yellow color without adversely affecting gloss, the problem of achieving lighter white articles by adding compensating blue and red colorants to one or more of the lower layers becomes even more difficult.

It would be desirable to be able to produce a multi-layer article with a reduced contribution of color, especially yellow, from the top layer, thereby reducing the amount of compensating colorants that must be added and thus allowing lighter white articles to be produced.

### SUMMARY

The present disclosure provides multi-layer articles which are weatherable and have enhanced color characteristics. The multi-layer articles possess at least three layers: a substrate, a transparent surface film, and a transparent intermediate layer therebetween possessing a refractive index lower than that of the surface film.

In one of its aspects, the present disclosure includes multilayer articles that include:
at least one substrate layer comprising a first material;
an intermediate layer; and
a surface film thereon, said surface film comprising a thermoplastic polyester different from said intermediate layer,
   wherein the surface film and intermediate layers are both transparent and the intermediate layer has an index of refraction lower than the index of refraction of the surface film.

The substrate layer in the articles of this disclosure can be any material capable of receiving an adherent intermediate layer. Suitable materials include metals, ceramics, cellulosic products and resins. The applicable resins include thermoset and, especially, thermoplastic polymer(s), whether addition or condensation prepared.

The intermediate layer is a transparent polymeric material with a lower refractive index than that of the surface film and, preferably, lower than the index of refraction of the substrate. As used herein, the terms “transparent” and “transparency” are used interchangeably and refer to materials capable of transmitting light waves without scattering so that materials on one side of the material may be clearly seen when viewed through the material. The term transparent is intended to encompass all grades of thermoplastic polymers that are “near transparent” as well as transparent. The intermediate layer reduces the amount of yellow light emitted from the multi-layer article thereby improving the color characteristics of the article. In a preferred embodiment, a poly(methyl methacrylate) is used as the intermediate layer.

The surface film improves weatherability and solvent resistance of the article, and can be used to modify the color and appearance of the thermoplastic material. The transparent surface film is preferably a resorcinol polyarylate or a resorcinol polyarylate copolymer, such as an isophthalate/terephthalate/resorcinol (“ITR”) polyarylate.

Another aspect of the present disclosure is a method for preparing a multi-layer article which comprises applying an intermediate layer to a substrate and then applying a surface film thereto. Alternatively, the intermediate layer may be applied to the surface film, and then the two may be applied to a substrate. Preferably, the intermediate layer acts as an adhesive capable of adhering the surface film to the substrate thereby forming a cohesive multi-layer article.

Still another aspect of the present disclosure is multi-layer articles prepared by the aforementioned method. In one embodiment the surface film, intermediate layer and substrate form a multi-layer film which, in turn, is applied to a second substrate.

### BRIEF DESCRIPTION OF THE DRAWINGS

FIG. 1 is a depiction of light transmission of an article possessing a surface film on a substrate without an intermediate layer.

FIG. 2 is a depiction of light transmission of an article possessing a surface film on a substrate with an intermediate layer having an index of refraction lower than that of the surface film.

### DETAILED DESCRIPTION OF PREFERRED EMBODIMENTS

Multilayer articles of the present disclosure include, but are not limited to, those which comprise a substrate layer, an intermediate layer on the substrate layer, and a surface film over the intermediate layer; those which comprise a substrate layer with an intermediate layer and surface film on each side of said substrate layer; and those which comprise a substrate layer, an intermediate layer and at least one surface film with at least one additional interlayer between the substrate layer and intermediate layer or between the intermediate layer and the surface film. Any interlayer may be transparent and/or may contain an additive, for example a colorant or decorative material such as metal flake. If desired, an overlayer may be included over the surface film, for example to provide abrasion or scratch resistance. The substrate, intermediate layer, surface film, and any interlayers or overcoating layers are preferably in contiguous superimposed contact with one another. In one aspect of the present disclosure, the substrate, intermediate layer and surface film are then applied to a second substrate.

The first material comprising the substrate layer in the articles of this disclosure may be any material capable of receiving an adherent intermediate layer. Suitable materials include glass, metals, ceramics, cellulosic products and resins. The applicable resins include thermoset and, especially, thermoplastic polymer(s), whether addition or condensation prepared.

Representative metal substrates include those comprising brass, aluminum, magnesium, chrome, iron, steel, copper, and other metals or alloys or articles containing them, which may require protection from UV-light or other weather phenomena.

Thermoset polymer substrates may include those derived from epoxies, cyanate esters, unsaturated polyesters, diallyl phthalate, acrylics, alkyds, phenolformaldehyde (including novolacs and resoles), melamine-formaldehyde, ureaformaldehyde, bismaleimides, PMR resins, benzocyclobutanes, hydroxymethylfurans and isocyanates. The present disclosure also encompasses multilayer articles comprising a filled thermoset substrate layer such as a sheet molding compound (SMC), suitable fillers being listed hereinafter.

Cellulosic materials which may be used as substrates include wood, paper, cardboard, fiber board, particle board, plywood, construction paper, Kraft paper, and like cellulosic-containing materials. The present disclosure also encompasses blends of at least one cellulosic material and either at least one thermoset polymer (preferably an adhesive thermoset polymer), or at least one thermoplastic polymer (preferably a recycled thermoplastic polymer, such as PET or polycarbonate), or a mixture of at least one thermoset polymer and at least one thermoplastic polymer.

Suitable condensation polymer substrates include aromatic polycarbonates, polyesters, polyphenylene ethers, and polyamides. Suitable polycarbonates include homo- and copolycarbonates comprising structural units of the formula 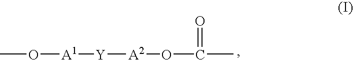
wherein each A¹ and A² is a monocyclic divalent aryl radical and Y is a bridging radical in which one or two carbon atoms separate A¹ and A². For example, A¹ and A² typically represent unsubstituted phenylene or substituted derivatives thereof. The bridging radical Y is most often a hydrocarbon group and particularly a saturated group such as methylene, cyclohexylidene or isopropylidene. The most preferred polycarbonates are bisphenol A polycarbonates, in which each of A¹ and A² is p-phenylene and Y is isopropylidene. Preferably, the weight average molecular weight of the initial polycarbonate composition ranges from about 5,000 to about 100,000; more preferably, from about 15,000 to about 65,000, with a range of from about 18,000 to about 35,000 being most preferred. The polycarbonate may also be a copolyestercarbonate. Such polymers contain, in addition to the carbonate units of formula I, ester units typically containing A¹-Y-A² moieties linked to aromatic dicarboxylate groups such as isophthalate and/or terephthalate.

Suitable polyesters which may be used as substrates include poly(alkylene dicarboxylates), especially poly(ethylene terephthalate) (hereinafter sometimes designated “PET”), poly(1,4-butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(butylene naphthalate) (hereinafter sometimes designated “PBN”), poly(cyclohexanedimethanol terephthalate), poly(cyclohexanedimethanol-co-ethylene terephthalate) (hereinafter sometimes designated “PETG”), and poly(1,4-cyclohexanedimethyl-1,4-cyclohexanedicarboxylate) (hereinafter sometimes designated “PCCD”).

Suitable addition polymer substrates include homo- and copolymeric aliphatic olefin and functionalized olefin polymers such as polyethylene, polypropylene, poly(vinyl chloride), poly(vinyl chloride-co-vinylidene chloride), poly(vinyl fluoride), poly(vinylidene fluoride), poly(vinyl acetate), poly(vinyl alcohol), poly(vinyl butyral), poly(acrylonitrile), acrylic polymers such as those of (meth)acrylamides or of alkyl (meth)acrylates such as poly(methyl methacrylate) (“PMMA”), and polymers of alkenylaromatic compounds such as polystyrenes, including syndiotactic polystyrene. The preferred addition polymers for many purposes are polystyrenes and especially the so-called “ABS” and “ASA” copolymers, which contain thermoplastic, non-elastomeric styrene-acrylonitrile side chains grafted on an elastomeric base polymer of butadiene and alkyl acrylate, respectively.

Blends of any of the foregoing polymers may also be employed. These include blends of thermoset polymers with thermoplastic polymers such as polyphenylene ether, polyphenylene sulfide, polysulfone, polyetherimide or polyester. The thermoplastic polymer is typically combined with thermoset monomer mixture before curing. Also included are blends of cellulosic materials and thermoset and/or thermoplastic polymers. Among blends, thermoplastic blends are often preferred. Especially preferred are blends of polyphenylene ether with polystyrene; polycarbonates with polyesters, ABS copolymers and/or ASA copolymers; and polyphenylene oxides with polyamides, with polycarbonate-polyester blends frequently being most preferred. The blends can include commonly used additives such as impact modifiers, compatibilization agents, and the like.

The preferred thermoplastic polymers for the substrate layer are, for the most part, polycarbonates, ABS copolymers, ASA copolymers and blends of polycarbonates with polyesters, ABS copolymers and ASA copolymers. Other thermoplastic polymers may be present therein, but the above-described polymers or blends more preferably constitute the major proportion thereof.

The substrate may also incorporate fillers such as silicates, zeolites, titanium dioxide, stone powder, glass fibers or spheres, carbon fibers, carbon black, graphite, calcium carbonate, talc, mica, lithopone, zinc oxide, zirconium silicate, iron oxide, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers and carbon fibers, as well as colorants such as metal flakes, glass flakes and beads, ceramic particles, other polymer particles, dyes and pigments which, in turn, may be organic, inorganic or organometallic.

Where the desired color of the multi-layered article is white, suitable colorants include titanium dioxide, zinc oxide, zinc sulfide, zirconium dioxide, white lead, lead sulfate, lead chloride, lead aluminate, lead phthalate, antimony trioxide, white bismuth, tin oxide, white manganese, white tungsten, and combinations thereof. In addition, optical brighteners, UV stabilizers and light stabilizers may be added to enhance the lightness of the article.

The next layer of the multi-layered article of the present disclosure is an intermediate layer composed of a transparent material that has an index of refraction lower than that of the surface film. Suitable intermediate layers for use in accordance with the present disclosure include polymers which are substantially aliphatic. Some aromatic groups are allowable in such polymers so long as the refractive index is within an acceptable range. Suitable polymers include: poly(vinyl fluoride) and acrylate copolymers; poly(vinylidine difluoride) and acrylate copolymers; poly(vinyl chloride) and copolymers; poly(vinylidine dichloride) and copolymers; poly(oxymethylene); poly(oxyethylene); poly(oxypropylene); poly(vinyl alkylethers); silicones, including poly(dimethylsiloxanes) and their functional derivatives; poly(alkyl acrylates); poly(alkyl methacrylates); poly(N-alkyl amides); poly(vinyl alkanoates), e.g., poly(vinyl acetate), poly(vinyl butyrate), etc. as well as mixed esters; cellulose alkanoates, e.g., cellulose acetate, cellulose butyrate, cellulose propionate, etc. as well as mixed esters; cellulose benzoate; polyethylene (all densities); polyethylene ionomers; polypropylenes (all tacticities); poly(butylene) (all tacticities); poly(isobutylene) (all tacticities); poly(isoprene); aliphatic polyesters, e.g., poly(ethylene succinate), poly(caprolactone), poly(cyclohexyldimethyl cyclohexyldicarboxylate), and related structures; aliphatic polycarbonates, e.g., poly(hexamethylene carbonate); aliphatic polyurethanes, e.g., products of aliphatic diisocyanate and any aliphatic diamine; poly(ethylene-co-propylene) (EPR rubber); poly(ethylene-co-propylene) ionomers; poly(vinyl butyral); poly(vinyl alcohol); poly(acrolein); natural rubber; poly(butadiene) rubbers; melamine resins; urea-formaldehyde resins; and aliphatic epoxy resins. In all cases, the use of the term alkyl includes C₁₋₁₆ hydrocarbons (linear, branched, cyclic, and unsaturated) and can include fluorine or chlorine substitution. In many cases, copolymers of the above materials may be used and, in some instances, will possess superior properties compared to the homopolymers. In addition, blends of these polymers with each other or with 1-50% of an aromatic polymer can be used.

Preferably, poly(alkyl methacrylates) are used as the intermediate layer, with poly(methyl methacrylate) (“PMMA”) being most preferred.

The intermediate layer has an index of refraction lower than the index of refraction of the surface film and, preferably, lower than the index of refraction of the substrate. Preferably, the intermediate layer has an index of refraction lower than about 1.60, more preferably ranging from about 1.3 to about 1.55. Where PMMA is the intermediate layer, the index of refraction is about 1.49.

Also present in the multi-layer articles of the present disclosure is a transparent surface film over the intermediate layer. Preferably, the surface film is a thermoplastic polyester possessing structural units derived from a 1,3-dihydroxybenzene organodicarboxylate. Suitable polymers for this purpose, specifically arylate polymers, are disclosed in U.S. Pat. No. 6,143,839. Arylate polymers having a glass transition temperature of at least about 80° C. and no crystalline melting temperature, i.e., those that are amorphous, are most preferred.

The arylate polymer is typically a 1,3-dihydroxybenzene isophthalate/terephthalate comprising structural units of the formula 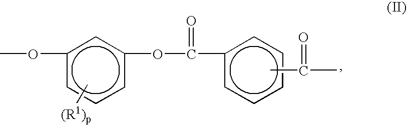
wherein each R¹ is a substituent, especially halo or C₁₋₁₂ alkyl, and p is 0-3, optionally in combination with structural units of the formula 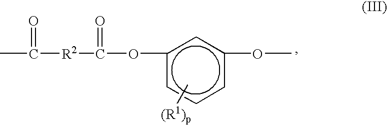
wherein R¹ and p are as previously defined and R² is a divalent C₄₋₁₂ aliphatic, alicyclic or mixed aliphatic-alicyclic radical.

It is within the scope of the present disclosure for other acid groups, such as those derived from aliphatic dicarboxylic acids such as succinic acid, adipic acid or cyclohexane-1,4-dicarboxylic acid, or from other aromatic dicarboxylic acids such as 1,8-naphthalenedicarboxylic acid, to be present in the coating layer, preferably in amounts no greater than about 30 mole percent. It is also within the scope of the present disclosure for other polyesters which are miscible in at least some proportions with the arylate polymer to be present; these are exemplified by PBT, PET, PTT, and PCCD. Most often, however, the coating layer polymer consists of units of formula II, optionally in combination with units of formula III.

The units of formula II preferably contain a resorcinol or substituted resorcinol moiety in which any R¹ groups are preferably C₁₋₄ alkyl; i.e., methyl, ethyl, propyl or butyl. They are preferably primary or secondary groups, with methyl being more preferred. The most preferred moieties are resorcinol moieties, in which p is zero, although moieties in which p is 1 are also excellent with respect to the present disclosure. Said resorcinol moieties are preferably bound to isophthalate and/or terephthalate moieties.

In the optional soft block units of formula III, resorcinol or substituted resorcinol moieties are again present in ester-forming combination with R² which is a divalent C₄₋₁₂ aliphatic, alicyclic or mixed aliphatic-alicyclic radical. It is preferably aliphatic and especially C₈₋₁₂ straight chain aliphatic.

Arylate polymers useful in the articles of this disclosure may be prepared by conventional esterification reactions which are known in the art. For example, such reactions may be conducted interfacially, in solution, in the melt or under solid state conditions. Interfacial preparation conditions and multi-layer articles produced thereby are described in U.S. Pat. Nos. 6,306,507, 6,265,522, 6,291,589, 6,294,647 and 5,916,997.

Also useful as arylate polymers according to the present disclosure are the block copolyestercarbonates described in U.S. Pat. No. 6,559,270. They include block copolymers comprising moieties of the formula 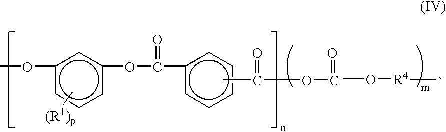
wherein R¹ and p are as previously defined, each R⁴ is independently a divalent organic radical, m is at least about 10 and n is at least about 4. Soft block moieties corresponding to formula III may also be present. The arylate blocks thus also contain an unsubstituted or substituted 1,3-dihydroxybenzene moiety. The most preferred moieties are again resorcinol moieties, in which p is zero.

Said 1,3-dihydroxybenzene moieties are bound to aromatic dicarboxylic acid moieties which may be monocyclic, e.g., isophthalate or terephthalate, or polycyclic, e.g., naphthalenedicarboxylate. Preferably, the aromatic dicarboxylic acid moieties are isophthalate and/or terephthalate. Either or both of said moieties may be present. For the most part, both are present in a molar ratio of isophthalate to terephthalate in the range of about 0.25-4.0:1, preferably about 0.4-2.5:1, more preferably about 0.67-1.5:1, and most preferably about 0.9-1.1:1.

In one embodiment, the arylate polymers are prepared by interfacial methods and contain units of formula II, preferably combinations of resorcinol isophthalate and terephthalate units in a molar ratio in the range of about 0.25-4.0:1, preferably about 0.4-2.5:1, more preferably about 0.67-1.5:1, and most preferably about 0.9-1.1:1. In such an embodiment, the presence of soft block units of formula IV is unnecessary. If the ratio of units of formula III is outside this range, and especially when they are exclusively iso- or terephthalate, the presence of soft block units may be preferred to facilitate interfacial preparation. A particularly preferred arylate polymer containing soft block units is one consisting of resorcinol isophthalate and resorcinol sebacate units in a molar ratio between 8.5:1.5 and 9.5:0.5.

The block copolyestercarbonates may be prepared by a two-step method in which a 1,3-dihydroxybenzene, which may be resorcinol (preferably) or an alkyl- or haloresorcinol, is first contacted under aqueous alkaline reactive conditions with at least one aromatic dicarboxylic acid chloride, preferably isophthaloyl chloride, terephthaloyl chloride or a mixture thereof. The alkaline conditions are typically provided by introduction of an alkali metal hydroxide, usually sodium hydroxide. A catalyst, most often a tertiary amine, tetraalkylammonium, tetraalkylphosphonium or hexaalkylguanidinium halide, is usually also present, as is an organic solvent, generally a water-immiscible solvent and preferably a chlorinated aliphatic compound such as methylene chloride. Thus, the reaction is generally conducted in a 2-phase system.

In order to afford a hydroxy-terminated polyester intermediate, the molar ratio of resorcinol to acyl chlorides is preferably greater than 1:1; e.g., in the range of about 1.01-1.90:1. Base may be present in a molar ratio to acyl halides of about 2-2.5:1. Catalyst is usually employed in the amount of about 0.1-10 mole percent based on combined acyl halides. Reaction temperatures are most often in the range of about 25-50° C.

Following the completion of polyester intermediate preparation, it is sometimes advantageous to acidify the aqueous phase of the two-phase system with a weak acid prior to phase separation. The organic phase, which contains the polyester intermediate, is then subjected to a second step which is the block copolyestercarbonate-forming reaction. It is also contemplated, however, to proceed to said second step without acidification or separation, and this is often possible without loss of yield or purity.

It is also possible to prepare the polyester intermediate entirely in an organic liquid, with the use of a base soluble in said liquid. Suitable bases for such use include tertiary amines such as triethylamine.

The dihydroxyaromatic compound employed in the second step typically has the formula HO—R⁴—OH, wherein R⁴ is as previously defined. Bisphenol A is generally preferred. The carbonyl halide is preferably phosgene. This reaction may be conducted according to art-recognized interfacial procedures (i.e., also in a 2-phase system), employing a suitable interfacial polymerization catalyst and an alkaline reagent, again preferably sodium hydroxide, and optionally a branching agent such as 1,1,1-tris(4-hydroxyphenyl)-ethane and/or a chain termination agent such as phenol or p-cumyl-phenol. To suppress scrambling of the block copolymer, the pH is maintained at a relatively low level, typically in the range of about 5-9, for the initial part of the phosgenation reaction; it may be increased to about 10-13 during the latter part of said reaction.

Following completion of both reactions, the block copolyestercarbonate may be isolated by conventional procedures. These may include, for example, anti-solvent precipitation, drying and pelletization via extrusion. It is also contemplated to conduct the first step by other ester-forming methods, as illustrated by transesterification using aromatic diesters and a 1,3-dihydroxybenzene either in a solvent or in the melt.

The surface film can have an index of refraction ranging from about 1.65 to about 1.59, with an index of refraction of about 1.625 being present for most resorcinol polyarylates.

In one preferred embodiment the surface film is a substantially transparent layer of resorcinol polyarylate or a resorcinol polyarylate copolymer, the intermediate layer is a poly(alkyl methacrylate) such as PMMA, and the substrate layer is a polycarbonate such as poly(bisphenol-A carbonate) containing a light-scattering pigment.

In the method of the present disclosure, an intermediate layer is applied to a substrate, and a surface film is then applied to the intermediate layer. The surface film may be the same as the substrate, but the intermediate layer is different from the substrate and surface film. Preferably, the intermediate layer is specifically chosen so as to provide good adhesion between substrate and surface film. Colorants may be present in the substrate, the surface film, or both, but any colorant added to the surface film should not affect the transparency of the surface film. Interlayers, which may be made of the same material as the substrate, surface film, or both, may also be included between the intermediate layer and surface film, between the intermediate layer and substrate, or both. In some embodiments, colorants are added to the interlayer.

Suitable methods for application include fabrication of a substrate followed by application to the substrate of a second material to form the intermediate layer, followed by application of a third material to the intermediate layer to form the surface film. Alternatively, a surface film may be formed, an intermediate layer applied thereto, and then a substrate may be applied to the intermediate layer.

The articles of this disclosure may also be prepared by solution coating or by melt methods such as co-injection molding, coextrusion, overmolding, multi-shot injection molding, sheet molding and placement of a film of the intermediate layer material on the surface of the substrate followed by adhesion of the two layers, typically in an injection molding apparatus, followed by application of the surface film to the intermediate layer in a similar fashion. In some cases, such as in multi-layer co-extrusion, the simultaneous production of these layers may be possible.

It is also within the scope of the present disclosure to apply to a substrate in a melt a structure comprising a surface film, an intermediate layer and an interlayer. This may be achieved, for example, by charging an injection mold with the surface film, then the intermediate layer, then the interlayer, and then injecting the substrate. By this method, in-mold decoration and the like are possible. Both sides of the substrate layer may receive these layers, though it is usually preferred to apply them to only one side.

The articles of the present disclosure can also be made by lamination of the layers by heat or by use of an adhesive. As noted above, aliphatic polyurethanes, silicones, and acrylic polymers, such as poly(methyl methacrylate), can be used as the intermediate layer. As all of these materials are known adhesives, in these embodiments the intermediate layer will act as an adhesive to join the surface film to the substrate and form a cohesive multi-layer article.

In one embodiment, the substrate could be extruded, an intermediate layer applied thereto by solution coating, and then a surface film could be laminated thereon after removal of the solvent from the solution coating. Alternatively, the surface film could first be formed, the intermediate layer applied thereto by solution coating, and then the two could be laminated onto a substrate after removal of the solvent from the solution coating.

It is also within the scope of the present disclosure to produce a multi-layer article, which includes a substrate, an intermediate layer and a surface film, and then apply this multi-layer article to a second substrate. In such a case the second substrate can be any material described above as a suitable substrate.

The thicknesses of the various resin layers in resinous articles of this disclosure are most often as follows: substrate—at least about 125μ (microns), preferably at least about 250μ, more preferably at least about 400μ; intermediate layer—about 1-1000μ, preferably about 5-500μ and most preferably about 10-100μ; surface film—about 2-2,500μ, preferably about 10-1000μ and most preferably about 10-250μ; interlayer, if any, about 2-2,500μ, preferably about 10-250μ, and most preferably about 50-175μ, total—at least about 125μ, preferably at least about 250μ, more preferably at least about 400μ.

The articles of this disclosure are characterized by the usual beneficial properties of the substrate layer, improved weatherability as evidenced by improved resistance to ultraviolet radiation and maintenance of gloss, and improved color characteristics. In accordance with the present disclosure, one can reduce the amount of compensating colorants that must be added to overcome the inherent base color of a material in a multi-layer system. This includes the ability to achieve a higher lightness in whites by adding less of the compensating colorants.

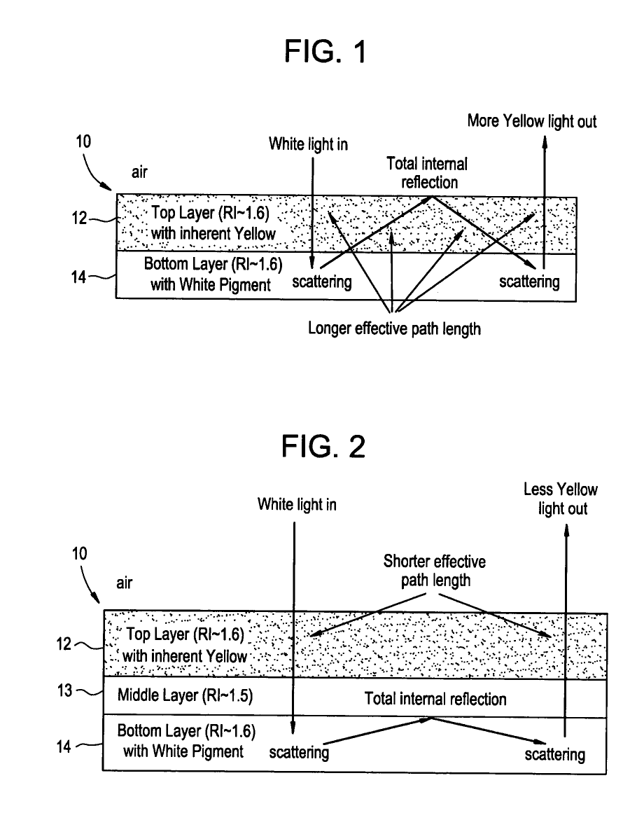

The benefit of having the intermediate layer with a lower refractive index is illustrated in FIGS. 1 and 2. In both of these figures, the multi-layer material 10 comprises a surface film 12 having an inherent yellow tint to it but does not contain any compensating colorants. The substrate 14 contains the pigments and dyes and is opaque. The refractive index of the surface film 12 and substrate 14 are nearly the same or the same. As depicted in FIG. 1, where no intermediate layer is present, light entering the material 10 from the top passes through the surface film 12 and enters the substrate 14 where it is scattered and adsorbed. The scattered light can leave the substrate 14 at a high angle and travel through the yellow surface film 12 giving it a long effective path length and thus more yellow light exits the article giving it a yellowish color, even though the surface film 12 may be thin.

As depicted in FIG. 2, to reduce the long effective path length and thus the yellow contribution of the surface film 12, the thin transparent intermediate layer 13 possessing a refractive index lower than that of the substrate 14 and surface film 12 is inserted between the substrate 14 and surface film 12. Light that now enters the material 10 from the top passes through the surface film 12 and intermediate layer 13 and then is scattered and adsorbed by the colorants in the substrate 14. The only light that can escape the substrate 14 is light that is more focused in the up and down direction due to the laws of refraction (i.e. Snell's law). The light that does leave the substrate 14 now travels in a direction that is closer to the material's surface normal and thus has a lower effective path length and lower yellow color contribution.

Articles produced in accordance with the present disclosure are suitable for a wide variety of uses. As noted above, the multi-layer article may include a second, or more, substrates. Articles which may be produced in accordance with the present disclosure include exterior body panels and parts for outdoor vehicles and devices including automobiles, protected graphics such as signs, outdoor enclosures such as telecommunication and electrical connection boxes, and construction applications such as roof sections, wall panels and glazing. The present disclosure further contemplates additional fabrication operations on said articles, such as, but not limited to, molding, in-mold decoration, baking in a paint oven, lamination, and/or thermoforming.

Multilayer articles of the present disclosure particularly include articles which will be exposed to UV-light, whether natural or artificial, during their lifetimes, and most particularly outdoor articles; i.e., those intended for outdoor use. Suitable articles are exemplified by automotive, truck, military vehicle, and motorcycle exterior and interior components, including panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, parts, and trim for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, countertops, windows, window trim, floors, decorative window furnishings or treatments; treated glass covers for pictures, paintings, posters, and like display items; refractors; sheaths for fluorescent tubes; sleeve guards; wall panels, doors and door trim; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications.

The present disclosure is illustrated by the following non-limiting examples.

### EXAMPLES

### Example 1

Laminate 1-A, a control, was prepared by placing a 10 mil film of resorcinol polyarylate on an injection molded plaque of Lexan 140 grade polycarbonate (commercially available from General Electric Company, Niskayuna, New York) containing 5% titanium dioxide pigment in a mold. The resorcinol polyarylate was a block copolymer of resorcinol polyarylate and BPA polycarbonate (in a 80:20 ratio) prepared according to U.S. Pat. No. 6,559,270 and extruded into a film 10 mils thick. The mold was covered with polished plates, placed in a hydraulic press equipped with platens heated to 175° C., pressed for 3 minutes at 500 psi pressure, 1 minute at 4,000 psi, and 1 minute at 6,000 psi. After cooling, the resorcinol polyarylate film was firmly adhered to the white polycarbonate substrate.

Laminate 1-B was prepared in an identical fashion except that a 1 mil poly(methyl methacrylate) film was placed between the 10 mil film of resorcinol polyarylate and the white polycarbonate substrate. The 1 mil thick PMMA film was prepared by dissolving Elvacite 2041 grade PMMA in chloroform to make a 20% solution and casting on a glass plate using a doctor blade to draw a 6 mil wet film that was allowed to dry.

Laminates 1-A and 1-B were exposed in an Atlas Ci35a xenon arc Weatherometer (Atlas Material Testing Technology LLC, Chicago, Ill.) under conditions specified in ASTM G26, except using an irradiance of 0.75 W/m². The color of the plaques was measured by reflection on a GretagMacbeth ColorEye 7000a spectrometer (GretagMacbeth LLC, New Windsor, N.Y.) and is reported as yellowness index according to ASTM D1925. The color shifts are shown in Table 1 below. The laminate incorporating a PMMA interlayer (Laminate 1-B) consistently had a change in yellowness index about 2 units less than the control sample (Laminate 1-A).

TABLE 1

| | Exposure | Delta YI (ASTM D1925) | |
|---|---|---|---|
| Exposure hours | kJ/m² at 340 nm | Laminate 1-A | Laminate 1-B |
| 120 | 324 | 18.2 | 16.3 |
| 586 | 1583 | 20.2 | 18.4 |

### Example 2

The procedure from Example 1 was followed except that that 3% of a benzoxazinone UV absorber (Cyasorb UV 3638 absorber (Cytec Industries Inc., West Paterson, N.J.)) was added to the resorcinol polyarylate-Bisphenol A polycarbonate copolymer before extrusion of the film. Laminate 2-A was prepared using the resorcinol polyarylate copolymer film and Laminate 2-B was prepared using the resorcinol polyarylate film plus the PMMA film as described in Example 1. The samples were expsoed to visible light for 91 hours and then exposed in a xenon arc Weatherometer as described in Example 1. The color shifts are shown in Table 2 below. The laminate incorporation the PMMA interlayer consistently had a change in yellowness index about 2 units less than the control sample.

TABLE 2

| | Exposure | Delta YI (ASTM D1925) | |
|---|---|---|---|
| Exposure Hours | kJ/m² at 340 nm | Laminate 2-A | Laminate 2-B |
| 263 | 709 | 8.2 | 6.5 |
| 764 | 2064 | 10.1 | 8.3 |
| 1400 | 3780 | 12.0 | 10.2 |

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

1. A multilayer article comprising:
at least one substrate comprising a first material;
an intermediate layer; and
a surface film comprising a thermoplastic polyester different from said intermediate layer,
wherein the surface film and intermediate layer are both transparent and the intermediate layer has an index of refraction lower than the index of refraction of the surface film.

2 The article of claim 1 wherein the at least one substrate comprises at least one material selected from the group consisting of glass, metals, ceramics, cellulosic products and resins.

3. The article of claim 2 wherein the at least one substrate comprises at least one polycarbonate, polyester or addition polymer of an alkenylaromatic compound.

4. The article of claim 2 wherein the at least one substrate includes an additional component selected from the group consisting of fillers and colorants.

5. The article of claim 1 wherein the intermediate layer comprises poly(vinyl fluoride) and acrylate copolymers, poly(vinylidine difluoride) and acrylate copolymers, poly(vinyl chloride) and copolymers, poly(vinylidine dichloride) and copolymers, poly(oxymethylene), poly(oxyethylene), poly(oxypropylene), poly(vinyl alkylethers), silicones, poly(alkyl acrylates), poly(alkyl methacrylates), poly(N-alkyl amides), poly(vinyl alkanoates), cellulose alkanoates, cellulose benzoate, polyethylene, polyethylene ionomers, polypropylenes, poly(butylene), poly(isobutylene), poly(isoprene), aliphatic polyesters, aliphatic polycarbonates, aliphatic polyurethanes, poly(ethylene-co-propylene) (EPR rubber), poly(ethylene-co-propylene) ionomers, poly(vinyl butyral), poly(vinyl alcohol), poly(acrolein), natural rubber, poly(butadiene) rubbers, melamine resins, urea-formaldehyde resins, aliphatic epoxy resins, copolymers thereof, and blends thereof.

6. The article of claim 5 wherein the intermediate layer has an index of refraction ranging from about 1.3 to about 1.55.

7. The article of claim 5 wherein the intermediate layer is a poly(methyl methacrylate) having an index of refraction of about 1.49.

8. The article of claim 1 wherein the surface film comprises an arylate polymer.

9. The article of claim 8 wherein the arylate polymer contains resorcinol moieties bound to isophthalate and/or terephthalate moieties.

10. The article of claim 8 wherein the surface film further comprises at least one colorant.

11. The article of claim 1 further comprising an interlayer disposed between the intermediate layer and substrate.

12. The article of claim 1 wherein the article is selected from the group consisting of automotive, truck, military vehicle, and motorcycle exterior and interior components, panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks and running boards.

13. The article of claim 1 wherein the article is selected from the group consisting of enclosures, housings, panels, parts and trim for outdoor vehicles and devices.

14. The article of claim 1 wherein the article is selected from the group consisting of, electrical and telecommunication devices, outdoor furniture, aircraft components, boats and marine equipment, outboard motor housings, depth finder housings, personal water-craft, jet-skis, pools, spas, hot-tubs, steps, step coverings, building and construction applications, glazing, roofs, countertops, windows, window trim, floors, decorative window furnishings and treatments, treated glass covers for pictures, paintings, posters, and like display items, refractors, sheaths for fluorescent tubes, sleeve guards, wall panels, doors, door trim, protected graphics, outdoor and indoor signs, enclosures, housings, panels, and parts for automatic teller machines (ATM), enclosures, housings, panels, and parts for lawn and garden tractors, lawn mowers, lawn and garden tools, sports equipment, toys, enclosures, housings, panels, and parts for snowmobiles, recreational vehicle panels and components, playground equipment, articles made from plastic-wood combinations, golf course markers, utility pit covers, computer housings, desk-top computer housings, portable computer housings, lap-top computer housings, palm-held computer housings, monitor housings, printer housings, keyboards, FAX machine housings, copier housings, telephone housings, mobile phone housings, radio sender housings, radio receiver housings, light fixtures, lighting appliances, network interface device housings, transformer housings, air conditioner housings, cladding or seating for public transportation, cladding or seating for trains, subways, or buses, meter housings, antenna housings, cladding for satellite dishes, coated helmets, personal protective equipment, coated synthetic or natural textiles, coated photographic film, coated photographic prints, coated painted articles, coated dyed articles, coated fluorescent articles, and coated foam articles.

15. A method for preparing a multilayer article which comprises:
forming at least one substrate of at least one material selected from the group consisting of glass, metals, ceramics, cellulosic products and resins;
applying an intermediate layer to the at least one substrate; and
applying a surface film to the intermediate layer,
wherein the surface film and intermediate layer are both transparent and the intermediate layer has an index of refraction lower than the index of refraction of the surface film.

16. The method of claim 15 wherein the step of forming the at least one substrate comprises selecting a substrate from at least one polycarbonate, polyester or addition polymer of an alkenylaromatic compound.

17. The method of claim 15 wherein the step of forming the at least one substrate further comprises adding a component selected from the group consisting of fillers and colorants.

18. The method of claim 15 wherein the step of applying the intermediate layer comprises selecting an intermediate layer comprising poly(vinyl fluoride) and acrylate copolymers, poly(vinylidine difluoride) and acrylate copolymers, poly(vinyl chloride) and copolymers, poly(vinylidine dichloride) and copolymers, poly(oxymethylene), poly(oxyethylene), poly(oxypropylene), poly(vinyl alkylethers), silicones, poly(alkyl acrylates), poly(alkyl methacrylates), poly(N-alkyl amides), poly(vinyl alkanoates), cellulose alkanoates, cellulose benzoate, polyethylene, polyethylene ionomers, polypropylenes, poly(butylene), poly(isobutylene), poly(isoprene), aliphatic polyesters, aliphatic polycarbonates, aliphatic polyurethanes, poly(ethylene-co-propylene) (EPR rubber), poly(ethylene-co-propylene) ionomers, poly(vinyl butyral), poly(vinyl alcohol), poly(acrolein), natural rubber, poly(butadiene) rubbers, melamine resins, urea-formaldehyde resins, aliphatic epoxy resins, copolymers thereof, and blends thereof.

19. The method of claim 15 wherein the step of applying the intermediate layer comprises forming an intermediate layer having an index of refraction ranging from about 1.3 to about 1.55.

20. The method of claim 15 wherein the step of applying the intermediate layer comprises selecting a poly(methyl methacrylate) having an index of refraction of about 1.49 as the intermediate layer.

21. The method of claim 15 wherein the step of applying the surface film comprises selecting an arylate polymer as the surface film.

22. The method of claim 21 wherein the step of applying the surface film comprises selecting an arylate polymer containing resorcinol moieties bound to isophthalate and/or terephthalate moieties.

23. The method of claim 15 wherein the step of applying the surface film further comprises applying at least one colorant.

24. The method of claim 15 further comprising placing an interlayer between the intermediate layer and the at least one substrate.

25. The method of claim 15 wherein the steps of preparing the multi-layer article are by a method selected from the group consisting solution coating, co-injection molding, coextrusion, overmolding, multi-shot injection molding, sheet molding and lamination.

26. The method of claim 15 wherein the step of applying the intermediate layer comprises using the intermediate layer as an adhesive adhering the surface film to the at least one substrate thereby forming the multilayer article.

27. The method of claim 15 further comprising applying the multilayer article to a second substrate.

28. A multilayer article comprising:
at least one substrate comprising a polycarbonate;
an intermediate layer comprising a poly(methyl methacrylate); and
a surface film comprising an arylate polymer comprising resorcinol moieties bound to isophthalate and/or terephthalate moieties,
wherein the surface film and intermediate layer are both transparent and the intermediate layer has an index of refraction lower than the index of refraction of the surface film.

29. The article of claim 28 wherein the surface film further comprises at least one colorant.

30. The article of claim 28 further comprising an interlayer disposed between the intermediate layer and substrate.

31. The article of claim 28 wherein the article is selected from the group consisting of automotive, truck, military vehicle, and motorcycle exterior and interior components, panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks and running boards.

32. The article of claim 28 wherein the article is selected from the group consisting of enclosures, housings, panels, parts and trim for outdoor vehicles and devices.

33. The article of claim 28 wherein the article is selected from the group consisting of, electrical and telecommunication devices, outdoor furniture, aircraft components, boats and marine equipment, outboard motor housings, depth finder housings, personal water-craft, jet-skis, pools, spas, hot-tubs, steps, step coverings, building and construction applications, glazing, roofs, countertops, windows, window trim, floors, decorative window furnishings and treatments, treated glass covers for pictures, paintings, posters, and like display items, refractors, sheaths for fluorescent tubes, sleeve guards, wall panels, doors, door trim, protected graphics, outdoor and indoor signs, enclosures, housings, panels, and parts for automatic teller machines (ATM), enclosures, housings, panels, and parts for lawn and garden tractors, lawn mowers, lawn and garden tools, sports equipment, toys, enclosures, housings, panels, and parts for snowmobiles, recreational vehicle panels and components, playground equipment, articles made from plastic-wood combinations, golf course markers, utility pit covers, computer housings, desk-top computer housings, portable computer housings, lap-top computer housings, palm-held computer housings, monitor housings, printer housings, keyboards, FAX machine housings, copier housings, telephone housings, mobile phone housings, radio sender housings, radio receiver housings, light fixtures, lighting appliances, network interface device housings, transformer housings, air conditioner housings, cladding or seating for public transportation, cladding or seating for trains, subways, or buses, meter housings, antenna housings, cladding for satellite dishes, coated helmets, personal protective equipment, coated synthetic or natural textiles, coated photographic film, coated photographic prints, coated painted articles, coated dyed articles, coated fluorescent articles, and coated foam articles.
